(19) United States
(12) Patent Application Publication
(10) Pub. No.: US 2025/0184850 A1
(43) Pub. Date: Jun. 5, 2025

(54) ELECTRONIC DEVICE AND METHOD FOR CONTROLLING ELECTRONIC DEVICE

(71) Applicant: SAMSUNG ELECTRONICS CO., LTD., Suwon-si (KR)

(72) Inventors: Jaeyoung JIN, Suwon-si (KR); Junsuk KIM, Suwon-si (KR); Dongchul SONG, Suwon-si (KR); Jungeun LEE, Suwon-si (KR)

(21) Appl. No.: 19/045,495

(22) Filed: Feb. 4, 2025

Related U.S. Application Data
(63) Continuation of application No. PCT/KR2023/005450, filed on Apr. 21, 2023.

(30) Foreign Application Priority Data
Aug. 8, 2022 (KR) 10-2022-0098857
Sep. 19, 2022 (KR) 10-2022-0117683

(51) Int. Cl. H04W 36/30; H04B 17/318; H04B 17/382; H04W 76/34

(52) U.S. Cl. CPC H04W 36/30; H04B 17/328; H04B 17/382; H04W 76/34

(57) ABSTRACT

An electronic device includes a first communication circuit to perform first cellular communication with a first cellular network, a second communication circuit to perform second cellular communication with a second cellular network, and at least one processor. The processor performs operations of: connecting to the first cellular network and the second cellular network, determining a network to be disconnected based on whether at least one condition is satisfied among a first condition related to a surface heating temperature of the electronic device, a second condition related to a number of layers received through the first cellular communication and a number of layers received through the second cellular communication, and a third condition related to a magnitude of transmission power of the first communication circuit and the second communication circuit, transmitting a signal for releasing communication connection to the network, and disconnecting from the determined network based on the release signal.

### TECHNICAL FIELD

The present document relates to an electronic device that supports E-UTRA NR dual connectivity (EN-DC) and a method of controlling the electronic device.

### BACKGROUND ART

To meet demand due to ever-increasing wireless data traffic since the commercialization of the 4th generation (4G) communication system, there have been efforts to develop an advanced 5th generation (5G) communication system or pre-5G communication system. For this reason, the 5G or pre-5G communication system is also called a beyond 4G network communication system or post long term evolution (post LTE) system. The 5G communication system is considered to be implemented in a band of 6 GHz or less (e.g., 1.8 GHz band or 3.5 GHz band) or extremely high frequency (mmWave) bands (e.g., 28 GHz band or 39 GHz band) so as to accomplish higher data rates. To reduce propagation loss of radio waves and to increase a transmission range of radio waves in the ultra-frequency bands, beamforming, massive multiple-input multiple-output (massive MIMO), full dimensional MIMO (FD-MIMO), array antenna, analog beam-forming, and large-scale antenna techniques are under discussion for the 5G communication system.

### DISCLOSURE OF INVENTION

### Technical Problem

An electronic device supporting dual connectivity (DC) may operate simultaneously in an LTE network and a 5G network. The electronic device may, on the basis of identifying that internal and/or surface temperature is equal to or greater than (or exceeds) a designated value, release the connection with the 5G network and perform data transmission or reception through the LTE network. However, a situation may occur where the heat generation due to data transmission or reception through the LTE network is lower than the heat generation due to data transmission or reception through the NR network, and in the situation above, releasing the connection with the LTE network may be more efficient for suppressing heat generation than releasing the connection with the 5G network.

### Solution to Problem

An electronic device may include a first communication circuit configured to perform first cellular communication with a first cellular network, a second communication circuit configured to perform second cellular communication with a second cellular network, and at least one processor operatively connected to the first communication circuit and the second communication circuit. The processor may connect to the first cellular network and the second cellular network through the first communication circuit and the second communication circuit, determine a network to be released from connection, between the first cellular network and the second cellular network, on the basis of whether at least one condition is satisfied among a first condition related to surface heating temperature of the electronic device, a second condition related to the number of layers received through the first cellular communication and the number of layers received through the second cellular communication, and a third condition related to magnitude of transmission power of the first communication circuit and the second communication circuit, transmit a signal for releasing communication connection to a determined network between the first cellular network and the second cellular network, and perform a series of operations for releasing communication connection from the determined network on the basis of a response signal to the release signal.

A method of controlling an electronic device may include determining a network to be released from connection, between the first cellular network and the second cellular network, on the basis of whether at least one condition is satisfied among a first condition related to surface heating temperature of the electronic device, a second condition related to the number of layers received through the first cellular communication and the number of layers received through the second cellular communication, and a third condition related to magnitude of transmission power of the first communication circuit and the second communication circuit, transmitting a signal for releasing communication connection to a determined network between the first cellular network and the second cellular network, and performing a series of operations for releasing communication connection from the determined network on the basis of a response signal to the release signal. The first cellular network may include a long term evolution (LTE) network, and the second cellular network may include a new radio (NR) network.

According to an embodiment, the electronic device may compare the current consumed in the LTE network with the current consumed in the 5G network in a DC state, and release the connection with the network consuming more current, thereby reducing current consumption and decreasing heat generation.

### BRIEF DESCRIPTION OF DRAWINGS

FIG. 1 is a block diagram of an electronic device in a network environment according to an embodiment.

FIG. 2 is a block diagram of an electronic device for supporting legacy network communication and 5G network communication according to an embodiment.

FIG. 3 is a view illustrating a protocol stack structure of a network 100 for legacy communication and/or 5G communication, according to an embodiment.

FIGS. 4A, 4B, and 4C are views illustrating wireless communication systems providing a network for legacy communication and/or 5G communication, according to an embodiment.

FIG. 5 is a block diagram of an electronic device supporting dual connectivity according to an embodiment.

FIG. 6 illustrates temperature measurement results of each network in an EN-DC environment according to an embodiment, in a graph.

FIG. 7 is a flowchart for controlling heat generation in an electronic device in an EN-DC environment according to an embodiment.

FIG. 8 is a flowchart for controlling heat generation in an electronic device in an NE-DC environment according to an embodiment.

### MODE FOR THE INVENTION

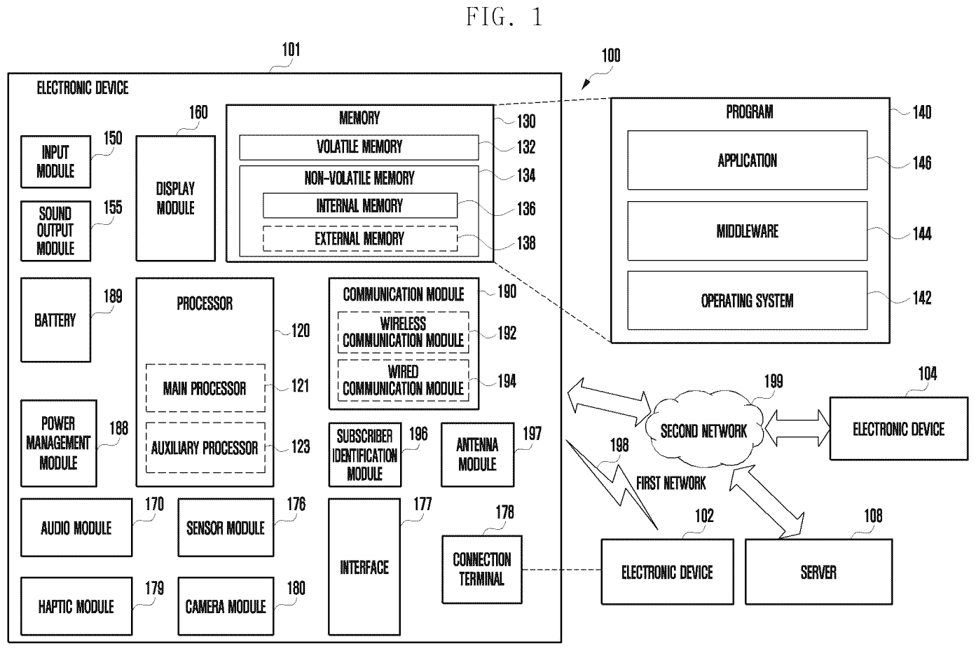

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

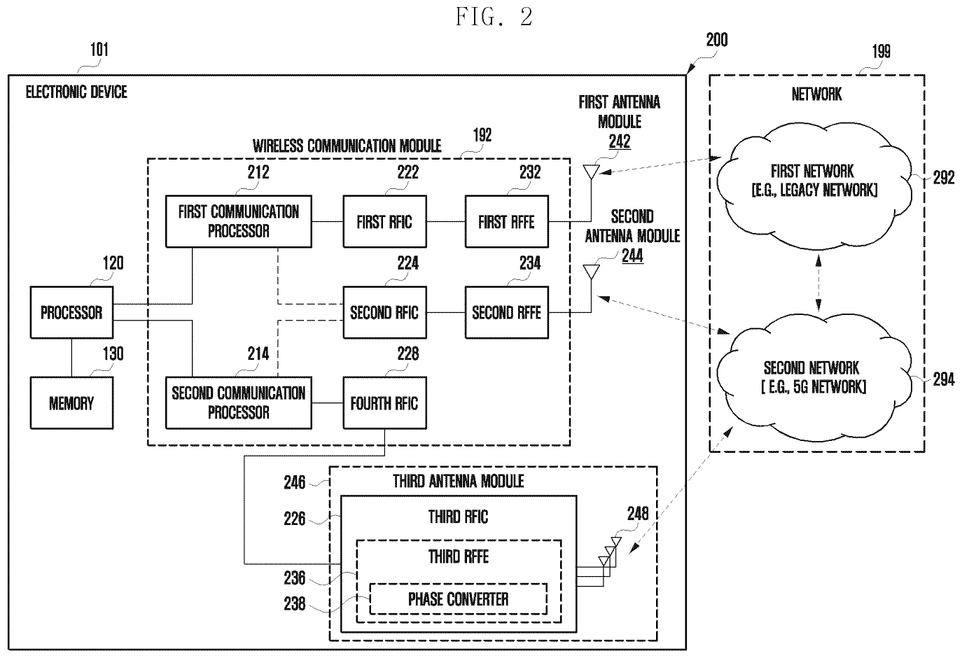

FIG. 2 is a block diagram of an electronic device 101 for supporting legacy network communication and 5G network communication, according to an embodiment.

With reference to FIG. 2, according to an embodiment, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The network 199 may include a first network 292 and a second network 294. According to an embodiment, the electronic device 101 may further include at least one of the components described in FIG. 1, and the network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least a portion of the wireless communication module 192. According to an embodiment, the fourth RFIC 228 may be omitted or included as a portion of the third RFIC 226.

The first communication processor 212 may support the establishment of a communication channel in a band to be used for wireless communication with the first network 292, and support legacy network communication through the established communication channel. According to an embodiment, the first network may be a legacy network including a second-generation (2G), 3G, 4G, or long term evolution (LTE) network. The second communication processor 214 may support the establishment of a communication channel corresponding to a designated band (e.g., about 6 GHz to about 60 GHz) among the bands to be used for wireless communication with the second network 294, and support 5G network communication through the established communication channel. According to an embodiment, the second network 294 may be new radio (NR) network (e.g., a 5G network), as defined by 3GPP. Additionally, according to an embodiment, the first communication processor 212 or the second communication processor 214 may support the establishment of a communication channel corresponding to another designated band (e.g., about 6 GHz or less) among the bands to be used for wireless communication with the second network 294, and support 5G network communication through the established communication channel. According to an embodiment, the first communication processor 212 and the second communication processor 214 may be implemented within a single chip or a single package. According to an embodiment, the first communication processor 212 or the second communication processor 214 may be formed within a single chip or a single package with the processor 120, the auxiliary processor 123, or the communication module 190.

According to an embodiment, the first communication processor 212 may transmit and receive data with the second communication processor 214. For example, data classified to be transmitted through the second network 294 may be changed to be transmitted through the first network 292.

In this case, the first communication processor 212 may receive transmission data from the second communication processor 214. For example, the first communication processor 212 may transmit and receive data through an inter-processor interface with the second communication processor 214. For example, the inter-processor interface may be implemented as a universal asynchronous receiver/transmitter (UART) (e.g., high speed-UART (HS-UART)) or a peripheral component interconnect bus express (PCIe) interface, but is not limited to these types. For example, the first communication processor 212 and the second communication processor 214 may exchange control information and packet data information using shared memory. For example, the first communication processor 212 may transmit and receive various information with the second communication processor 214, such as sensing information, information on output power, and resource block (RB) allocation information.

Depending on the implementation, the first communication processor 212 may not be directly connected to the second communication processor 214. In this case, the first communication processor 212 may transmit and receive data with the second communication processor 214 through the processor 120 (e.g., application processor). For example, the first communication processor 212 and the second communication processor 214 may transmit and receive data with the processor 120 (e.g., application processor) through an HS-UART interface or a PCIe interface, but the type of interface is not limited thereto. For example, the first communication processor 212 and the second communication processor 214 may exchange control information and packet data information with the processor 120 (e.g., application processor) using shared memory. According to an embodiment, the first communication processor 212 and the second communication processor 214 may be implemented within a single chip or a single package. According to an embodiment, the first communication processor 212 or the second communication processor 214 may be formed within a single chip or a single package with the processor 120, the auxiliary processor 123, or the communication module 190.

The first RFIC 222 may, during transmission, convert a baseband signal generated by the first communication processor 212 into a radio frequency (RF) signal of about 700 MHz to about 3 GHz, which is used for the first network 292 (e.g., legacy network). During reception, an RF signal may be obtained from the first network 292 (e.g., legacy network) through an antenna (e.g., first antenna module 242) and may be preprocessed through an RFFE (e.g., first RFFE 232). The first RFIC 222 may convert the preprocessed RF signal into a baseband signal to be processed by the first communication processor 212.

The second RFIC 224 may, during transmission, convert a baseband signal generated by the first communication processor 212 or the second communication processor 214 into an RF signal (hereinafter, 5G Sub6 RF signal) in the Sub6 band (e.g., about 6 GHz or less) used for the second network 294 (e.g., 5G network). During reception, the 5G Sub6 RF signal may be obtained from the second network 294 (e.g., 5G network) through an antenna (e.g., second antenna module 244) and may be preprocessed through an RFFE (e.g., second RFFE 234). The second RFIC 224 may convert the preprocessed 5G Sub6 RF signal into a baseband signal to be processed by the corresponding communication processor, either the first communication processor 212 or the second communication processor 214.

The third RFIC 226 may convert a baseband signal generated by the second communication processor 214 into an RF signal (hereinafter, 5G Above6 RF signal) in the 5G Above6 band (e.g., about 6 GHz to about 60 GHz) to be used for the second network 294 (e.g., 5G network). During reception, the 5G Above6 RF signal may be obtained from the second network 294 (e.g., 5G network) through an antenna (e.g., antenna 248) and may be preprocessed through the third RFFE 236. The third RFIC 226 may convert the preprocessed 5G Above6 RF signal into a baseband signal to be processed by the second communication processor 214. According to an embodiment, the third RFFE 236 may be formed as a portion of the third RFIC 226.

According to an embodiment, the electronic device 101 may include the fourth RFIC 228, either separately from or at least as a portion of the third RFIC 226. In this case, the fourth RFIC 228 may convert the baseband signal generated by the second communication processor 214 into an RF signal (hereinafter, IF signal) in an intermediate frequency band (e.g., about 9 GHz to about 11 Ghz), and transmit the IF signal to the third RFIC 226. The third RFIC 226 may convert the IF signal into the 5G Above6 RF signal. During reception, the 5G Above6 RF signal may be received from the second network 294 (e.g., 5G network) through an antenna (e.g., antenna 248) and may be converted into the IF signal by the third RFIC 226. The fourth RFIC 228 may convert the IF signal into a baseband signal to be processed by the second communication processor 214.

According to an embodiment, the first RFIC 222 and the second RFIC 224 may be implemented as at least a portion of a single chip or a single package. According to an embodiment, the first RFFE 232 and the second RFFE 234 may be implemented as at least a portion of a single chip or a single package. According to an embodiment, at least one of the first antenna module 242 or the second antenna module 244 may be omitted or combined with another antenna module to process RF signals of corresponding multiple bands.

According to an embodiment, the third RFIC 226 and the antenna 248 may be disposed on the same substrate to form a third antenna module 246. For example, the wireless communication module 192 or the processor 120 may be disposed on a first substrate (e.g., main PCB). In this case, the third RFIC 226 may be disposed in a partial area (e.g., lower surface) of the second substrate (e.g., sub PCB) separate from the first substrate, and the antenna 248 may be disposed in another partial area (e.g., upper surface) thereof, thereby forming the third antenna module 246. By disposing the third RFIC 226 and the antenna 248 on the same substrate, it is possible to reduce the length of the transmission line therebetween. This may, for example, reduce the loss (e.g., attenuation) of a high-frequency band signal (e.g., about 6 GHz to about 60 GHz) used for 5G network communication due to the transmission line. As a result, the electronic device 101 may improve the quality or speed of communication with the second network 294 (e.g., 5G network).

According to an embodiment, the antenna 248 may be formed as an antenna array including a plurality of antenna elements that may be used for beamforming. In this case, the third RFIC 226 may, for example, include a plurality of phase shifters 238 corresponding to the plurality of antenna elements as a portion of the third RFFE 236. During transmission, each of the plurality of phase shifters 238 may convert the phase of the 5G Above6 RF signal to be transmitted through the corresponding antenna element to the exterior of the electronic device 101 (e.g., a base station of the 5G network). During reception, each of the plurality of phase shifters 238 may convert the phase of the 5G Above6 RF signal received from the exterior through the corresponding antenna element to the same or substantially the same phase. This enables transmission or reception through beamforming between the electronic device 101 and the exterior.

The second network 294 (e.g., 5G network) may operate independently of the first network 292 (e.g., legacy network) (e.g., stand-alone (SA)) or may operate in connection with the first network 292 (e.g., non-stand alone (NSA)). For example, the 5G network may include only an access network (e.g., 5G radio access network (RAN) or next generation RAN (NG RAN)) without a core network (e.g., next generation core (NGC)). In this case, the electronic device 101 may access the access network of the 5G network and then access an external network (e.g., Internet) under the control of the core network of the legacy network (e.g., evolved packet core (EPC)). Protocol information for communication with the legacy network (e.g., LTE protocol information) or protocol information for communication with the 5G network (e.g., new radio (NR) protocol information) may be stored in the memory 130 and accessed by other components (e.g., processor 120, first communication processor 212, or second communication processor 214).

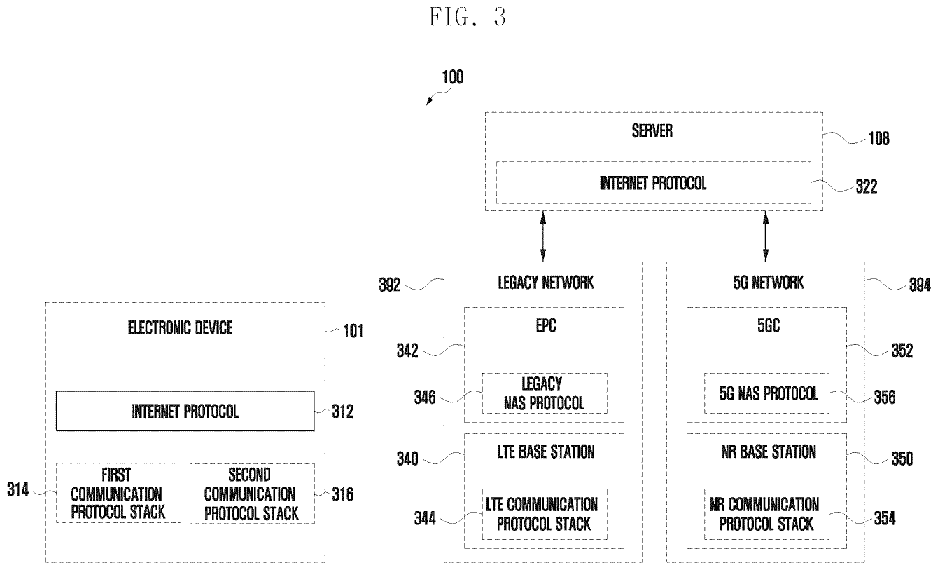

FIG. 3 is a view illustrating a protocol stack structure of the network 100 for legacy communication and/or 5G communication, according to an embodiment.

With reference to FIG. 3, according to an embodiment, the network 100 may include the electronic device 101, a legacy network 392, a NR network 394, and the server 108. Although the NR network 394 is described as a 5G network 394, it should be appreciated the subsequent NR networks (e.g., as defined by as defined by 3GPP) may be utilized without departing from the scope of the invention.

According to an embodiment, the electronic device 101 may include an Internet protocol 312, a first communication protocol stack 314, and a second communication protocol stack 316. For example, the electronic device 101 may communicate with the server 108 through the legacy network 392 and/or the 5G network 394.

According to an embodiment, the electronic device 101 may perform Internet communication associated with the server 108 using the Internet protocol 312 (e.g., transmission control protocol (TCP), user datagram protocol (UDP), Internet protocol (IP)). For example, the Internet protocol 312 may be executed by a main processor included in the electronic device 101 (e.g., main processor 121 in FIG. 1).

According to an embodiment, the electronic device 101 may wirelessly communicate with the legacy network 392 using the first communication protocol stack 314. According to another embodiment, the electronic device 101 may wirelessly communicate with the 5G network 394 using the second communication protocol stack 316. For example, the first communication protocol stack 314 and the second communication protocol stack 316 may be executed by one or more communication processors included in the electronic device 101 (e.g., wireless communication module 192 in FIG. 1).

According to an embodiment, the server 108 may include an Internet protocol 322. The server 108 may transmit and receive data related to the Internet protocol 322 with the electronic device 101 through the legacy network 392 and/or the 5G network 394. According to an embodiment, the server 108 may include a cloud computing server existing outside of the legacy network 392 or the 5G network 394. According to an embodiment, the server 108 may include an edge computing server (or mobile edge computing (MEC) server) positioned inside at least one of the legacy network or the 5G network 394.

According to an embodiment, the legacy network 392 may include a long term evolution (LTE) base station 340 and an evolved packet core (EPC) 342. The LTE base station 340 may include an LTE communication protocol stack 344. The EPC 342 may include a legacy non-access stratum (NAS) protocol 346. The legacy network 392 may perform LTE wireless communication with the electronic device 101 using the LTE communication protocol stack 344 and the legacy NAS protocol 346.

According to an embodiment, the 5G network 394 may include a new radio (NR) base station 350 and a 5th generation core (5GC) 352. The NR base station 350 may include an NR communication protocol stack 354. The 5GC 352 may include a 5G NAS protocol 356. The 5G network 394 may perform new radio (NR) wireless communication with the electronic device 101 using the NR communication protocol stack 354 and the 5G NAS protocol 356.

According to an embodiment, the first communication protocol stack 314, the second communication protocol stack 316, the LTE communication protocol stack 344, and the NR communication protocol stack 354 may include a control plane protocol for transmitting and receiving control messages and a user plane protocol for transmitting and receiving user data. For example, the control message may include a message related to at least one of security control, bearer setup, authentication, registration, or mobility management. For example, user data may include all data except for control messages.

According to an embodiment, the control plane protocol and user plane protocol may include physical (PHY), medium access control (MAC), radio link control (RLC), or packet data convergence protocol (PDCP) layers. For example, the PHY layer may channel code and modulate data received from an upper layer (e.g., MAC layer) and transmit the data over a wireless channel, and may demodulate and decode data received through the wireless channel to deliver the data to the upper layer. The PHY layer included in the second communication protocol stack 316 and the NR communication protocol stack 354 may further perform operations related to beam forming. For example, the MAC layer may logically/physically map data to a wireless channel for transmission and reception and may perform hybrid automatic repeat request (HARQ) for error correction. For example, the RLC layer may concatenate, segment, or reassemble data, and may perform sequence verification, reordering, or duplicate detection of data. For example, the PDCP layer may perform operations related to the ciphering of control data and user data, as well as data integrity. The second communication protocol stack 316 and the NR communication protocol stack 354 may further include a service data adaptation protocol (SDAP). For example, the SDAP may manage the allocation of radio bearers based on the quality of service (QoS) of user data.

According to an embodiment, the control plane protocol may include a radio resource control (RRC) layer and a non-access stratum (NAS) layer. For example, the RRC layer may process control data related to radio bearer setup, paging, or mobility management. For example, the NAS may process control messages related to authentication, registration, and mobility management.

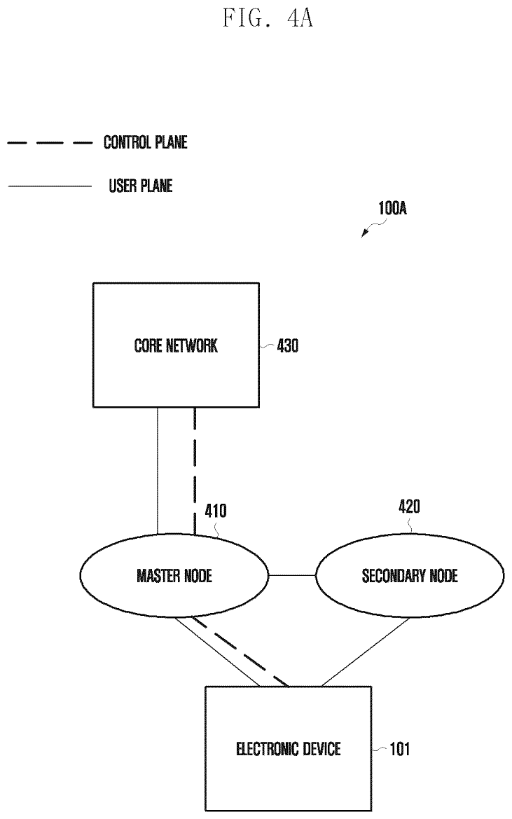

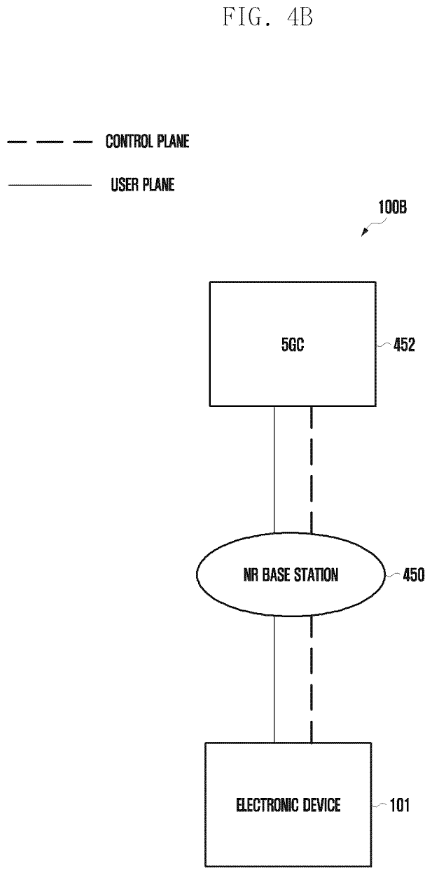

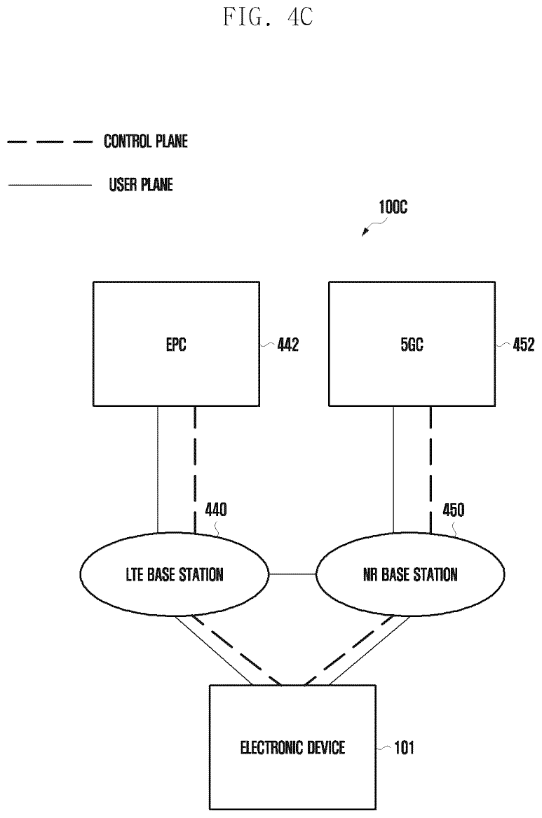

FIGS. 4A, 4B, and 4C are views illustrating wireless communication systems providing a network for legacy communication and/or 5G communication, according to an embodiment.

With reference to FIGS. 4A, 4B, and 4C, the network environments 100A to 100C may include at least one of a legacy network or a 5G network. For example, the legacy network may include a 4G or LTE base station 440 of the 3GPP standard (e.g., eNodeB (eNB)) that supports wireless access with the electronic device 101, and an evolved packet core (EPC) 442 that manages 4G communication. For example, the 5G network may include a new radio (NR) base station 450 (e.g., gNodeB (gNB)) that supports wireless access with the electronic device 101, and a 5th generation core (5GC) 452 that manages the 5G communication of the electronic device 101.

According to an embodiment, the electronic device 101 may transmit and receive control messages and user data through legacy communication and/or 5G communication. For example, the control message may include a message related to at least one of security control, bearer setup, authentication, registration, or mobility management of the electronic device 101. For example, user data may refer to user data transmitted and received between the electronic device 101 and the core network 430 (e.g., EPC 442), excluding control messages.

With reference to FIG. 4A, according to an embodiment, the electronic device 101 may transmit and receive at least one of control messages or user data with at least a portion of the 5G network (e.g., NR base station 450, 5GC 452) using at least a portion of the legacy network (e.g., LTE base station 440, EPC 442).

According to an embodiment, the network environment 100A may provide multi-RAT (radio access technology) dual connectivity (MR-DC) for wireless communication with the LTE base station 440 and the NR base station 450, and may include a network environment for transmitting and receiving control messages with the electronic device 101 through one of the core networks 430, either EPC 442 or 5GC 452.

According to an embodiment, in the MR-DC environment, one of the LTE base station 440 or the NR base station 450 may operate as a master node (MN) 410, and the other may operate as a secondary node (SN) 420. The MN 410 may be connected to the core network 430 and may transmit and receive control messages. The MN 410 and SN 420 may be connected through a network interface and may transmit and receive messages related to wireless resource management (e.g., communication channels) with each other.

According to an embodiment, the MN 410 may configured to be an LTE base station 440, the SN 420 may be an NR base station 450, and the core network 430 may be configured as the EPC 442. For example, control messages may be transmitted and received through the LTE base station 440 and EPC 442, and user data may be transmitted and received through the LTE base station 440 and the NR base station 450.

With reference to FIG. 4B, according to an embodiment, the 5G network may independently transmit and receive control messages and user data with the electronic device 101.

With reference to FIG. 4C, according to an embodiment, the legacy network and the 5G network may each independently provide data transmission and reception. For example, the electronic device 101 and the EPC 442 may transmit and receive control messages and user data through the LTE base station 440. For another example, the electronic device 101 and the 5GC 452 may transmit and receive control messages and user data through the NR base station 450.

According to an embodiment, the electronic device 101 may be registered with at least one of the EPC 442 or the 5GC 452 to transmit and receive control messages.

According to an embodiment, the EPC 442 or the 5GC 452 may interwork to manage the communication of the electronic device 101. For another example, movement information on the electronic device 101 may be transmitted and received through the interface between the EPC 442 and the 5GC 452.

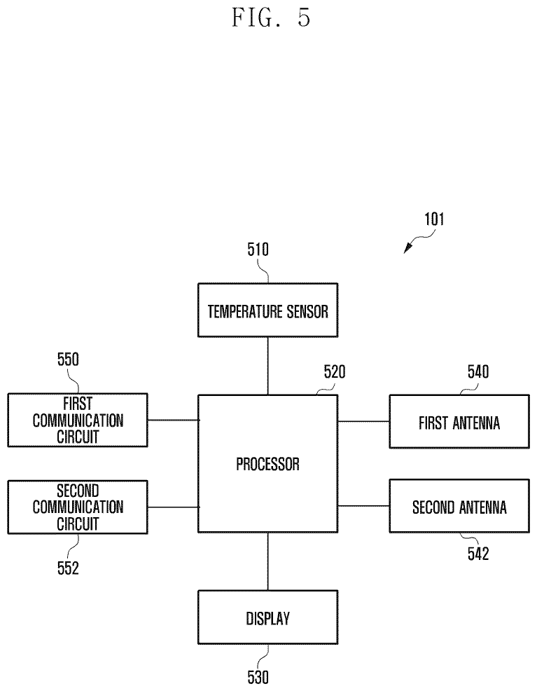

FIG. 5 is a block diagram of an electronic device supporting dual connectivity according to an embodiment.

With reference to FIG. 5, the electronic device (e.g., electronic device 101 in FIG. 1) according to a non-limiting embodiment of the present disclosure may include a temperature sensor (e.g., sensor module 175 in FIG. 1) 510, a processor (e.g., processor 120 in FIG. 1) 520, a display (e.g., display module 160 in FIG. 1) 530, a communication circuit (e.g., wireless communication module 192 in FIG. 1) 550, a first antenna 540, and a second antenna 542.

In an embodiment, the temperature sensor 510 may measure the temperature of at least a portion of the electronic device 101 (e.g., constituent elements of the electronic device 101 (e.g., housing and/or components)). The temperature information measured by the temperature sensor 510 may be transmitted to the processor 520.

In an embodiment, the processor 520 may be electrically and/or operatively connected to various constituent elements of the electronic device 101 and may control various constituent elements of the electronic device 101. At least one processor 520 may include one of an application processor or a communication processor.

In an embodiment, the display 530 may display various still images and/or videos on the basis of the control of the processor 520. The display 530 may display a screen provided by a foreground application. A foreground application may be defined as an application displayed on the display 530, while a background application may be defined as an application not displayed on the display 530. The foreground application may operate as a background application under certain conditions (e.g., when the user inputs the lock button of the electronic device 101). For example, a music playback application may be a foreground application that displays information related to music playback on the display 530, and may operate as a background application that performs music playback without providing a separate screen in lock mode.

The processor 520 may perform data transmission and/or reception through a first cellular communication and/or a second cellular communication. The processor 520 may be connected to a first node (e.g., LTE base station 440 in FIG. 4A) through the first cellular communication or to a second node (e.g., NR base station 450 in FIG. 4A) through the second cellular communication. The processor 520 may transmit user data received from the processor 520 through the first cellular communication and/or the second cellular communication, and may transmit user data received through the first cellular communication and/or the second cellular communication to the processor 520.

The first cellular communication may be one of the various cellular communication methods supported by the electronic device 101, and may refer, for example, to the communication method on the second cellular network 294 in FIG. 2. For example, the first cellular communication may be a communication method using a fourth-generation mobile communication method (e.g., long term evolution). The first cellular communication may include at least one antenna (e.g., first antenna 540).

The second cellular communication may be one of the various cellular communication methods supported by the electronic device (e.g., electronic device 101 in FIG. 1), and may refer, for example, to the communication method on the first cellular network 292 in FIG. 2. For example, the second cellular communication may be a communication method using a fifth-generation mobile communication method (e.g., new radio). The second cellular communication may include at least one antenna (e.g., second antenna 542).

According to a non-limiting embodiment, the first communication circuit 550 (e.g., a first wireless communication module) is a communication circuit that supports the first cellular communication and the second communication circuit 552 (e.g., a second wireless communication module) is a communication circuit that supports the second cellular communication. The first communication circuit 550 and/or the second communication circuit 552 may provide communication with an external electronic device (e.g., external electronic device 104 in FIG. 1) to the electronic device 101 through the first cellular communication and the second cellular communication, respectively.

In a non-limiting embodiment, the electronic device implements a single communication circuit 550, which is a communication circuit that supports the first cellular communication and/or the second cellular communication, and may provide communication with an external electronic device (e.g., external electronic device 104 in FIG. 1) to the electronic device 101 through the first cellular communication and/or the second cellular communication.

According to an embodiment, the electronic device 101, in a state of being in radio resource control (RRC) connection through the first cellular communication, may release the RRC connection of the first cellular communication and perform the RRC connection of the second cellular communication to reduce heat generation and/or power consumption. Hereinafter, a specific embodiment for releasing the RRC connection of the first cellular communication will be described.

In an embodiment, the processor 520 may identify a state of the display 530 while in an RRC-connected state through the first cellular communication. The processor 520 may identify whether the display 530 is in an inactive state. Alternatively, the processor 520 may detect that the display 530 switches from an active state to an inactive state and identify whether the inactive state of the display 530 is maintained for a designated period of time or longer.

The inactivity of the display 530 may indicate that at least a portion of the functions of the display 530 (e.g., a screen display function) is inactive. According to an embodiment, even if other functions of the display 530 (e.g., always-on display (AOD) function, touch input recognition function) are active, the inactive state of the screen display function may be defined as the inactivity of the display 530. Alternatively, the inactive state of the display 530 may include a state in which the current applied to the display 530 is relatively lower compared to the active state. For example, the inactive state of the display 530 may include at least one of a state in which the luminance of the display 530 is reduced, a dimming state, and/or a state in which the display 530 is turned off.

According to an embodiment, the display 530 may switch to an inactive state in response to detecting that the user presses the lock button of the electronic device 101. According to an embodiment, the display 530 may switch to an inactive state in response to not receiving user input on the display 530 for a designated period of time or longer. In addition to the embodiments described above, the display 530 may switch to an inactive state in various ways.

The processor 520 may, in response to identifying that the display 530 is in an inactive state, identify whether the temperature measured by the temperature sensor 510 and/or the throughput of data transmission satisfies a designated condition. Alternatively, the processor 520 may, in response to identifying that the inactive state of the display 530 is maintained for a designated period of time or longer, identify whether the temperature measured by the temperature sensor 510 and/or the throughput of data transmission satisfies a designated condition. Alternatively, a communication processor (not illustrated) may receive information from an application processor (not illustrated) indicating that a designated temperature condition has been satisfied, and identify whether the throughput of data transmission satisfies a designated condition.

In an embodiment, the electronic device 500 may include at least one temperature sensor. The temperature measured by the temperature sensor 510 may include the temperature of a portion of the electronic device 101 where the temperature sensor 510 is disposed. For example, the temperature sensor 510 may be included inside or attached to a surface of at least one constituent element of the electronic device 101 (e.g., the processor 520). Alternatively, at least one temperature sensor 510 may be positioned near the surface of the electronic device 101 to measure the surface temperature of the electronic device 101. The temperature of the electronic device 101 may be determined by a value measured by one temperature sensor when a plurality of temperature sensors 510 are included, or by combining the values measured by two or more temperature sensors. The processor 520 may identify whether the temperature measured by the temperature sensor 510 satisfies a designated condition. The designated condition may include a condition in which the temperature measured by the temperature sensor 510 is greater than or equal to (or exceeds) a designated value (e.g., 35.5 degrees).

The throughput of data transmission may be defined as the amount of traffic of data transmitted and/or received per unit of time. The processor 520 may monitor (or track) the amount of traffic generated by a running application (or a background application) while the display 530 is in an inactive state. The processor 520 may monitor (or track) the amount of traffic of data transmitted or received through the first cellular communication and/or the second cellular communication, and identify whether the throughput satisfies a designated condition. The designated condition may include a condition where the throughput is less than or equal to (or less than) a designated value (e.g., 10 Mbps).

The processor 520 may identify that the temperature and/or throughput does not satisfy the designated condition and may maintain the RRC connection of the first cellular communication. The temperature and/or throughput not satisfying the designated condition may indicate that the temperature of the electronic device 101 is less than or equal to the designated value, or that the throughput is greater than or equal to the designated value. Maintaining the RRC connection of the first cellular communication may indicate that the electronic device 101 may perform data transmission and/or reception through the first cellular communication. The processor 520 may, in response to identifying that the temperature and/or throughput does not satisfy the designated condition, maintain the RRC connection of the first cellular communication, and continuously identify the temperature and/or throughput to determine whether they satisfy the designated condition.

The processor 520 may identify that the temperature and/or throughput satisfies the designated condition and release the RRC connection of the first cellular communication. Alternatively, an application processor (not illustrated) may identify that the temperature and/or throughput satisfies the designated condition and transmit a message to a communication processor (not illustrated) indicating the release of the RRC connection of the first cellular communication.

The processor 520, as part of at least one operation for maintaining the release of the first cellular communication, may not transmit a B1 event measurement report that is configured to report when the signal strength transmitted by the node connected through the first cellular communication (e.g., LTE base station 440 in FIG. 4A) is greater than a specific value.

The network of the first cellular communication that receives the B1 event measurement report (e.g., second network 294 in FIG. 2) may determine whether to connect the RRC connection of the first cellular communication depending on whether the B1 event measurement report is received. When the network 294 of the first cellular communication receives the B1 event measurement report, the network 294 may re-perform the RRC connection between the electronic device 101 and the network 294 of the first cellular communication. Therefore, the processor 520 may maintain the release state of the first cellular communication by not transmitting the B1 event measurement report.

The embodiments described above provide details on releasing and/or maintaining the RRC connection of the first cellular communication on the basis of throughput and/or temperature, but the electronic device 101 may release and/or maintain the RRC connection of the first cellular communication in consideration of various states, not limited to throughput and/or temperature.

According to an embodiment, the processor 520 may be operatively connected to the communication circuit 550. According to an embodiment, the processor 520 may interact with the communication circuit 550 through an application processor to communication processor (AP2CP) interface. For example, the AP2CP interface may include at least one of a shared memory method or peripheral component interconnect express (PCIe). According to an embodiment, the communication circuit 550 may interact through a communication processor to communication processor (CP2CP) interface. For example, the CP2CP interface may include a universal asynchronous receiver/transmitter (UART).

According to an embodiment, the communication circuit 550 may perform the first cellular communication with a first node (e.g., master node 410 in FIG. 4A). According to an embodiment, the communication circuit 550 may perform the first cellular communication to transmit and/or receive control messages and data with the first node (e.g., MN 410). For example, the first cellular communication may include one of the various cellular communication methods that the electronic device 101 is capable of supporting. As an example, the first cellular communication may include at least one of one of fourth-generation mobile communication methods (e.g., long-term evolution (LTE), LTE-advanced (LTE-A), LTE advanced pro (LTE-A Pro)) or one of fifth-generation mobile communication methods (e.g., 5G or NR) (e.g., using a frequency band of about 6 GHz or less). As an example, the first node (e.g., MN 410) may refer to a base station that supports the first cellular communication. According to an embodiment, the communication processor (e.g., first communication processor 212 in FIG. 2) may include an RFIC (e.g., first RFIC 222 in FIG. 2) and/or an RFFE (e.g., first RFFE 232 in FIG. 2) related to the first cellular communication.

According to an embodiment, the communication circuit 550 may perform the second cellular communication with the second node (e.g., secondary node 420 in FIG. 4A). According to an embodiment, the communication circuit 550 may transmit and/or receive data with the second node (e.g., SN 420) while performing the second cellular communication. For example, the second cellular communication may include one of the various cellular communication methods that the electronic device 101 is capable of supporting. As an example, the second cellular communication may include one of the fifth-generation mobile communication methods (e.g., 5G) (e.g., using a frequency band of about 6 GHz or higher) or one of the fourth-generation mobile communication methods (e.g., LTE, LTE-A, LTE-A Pro). The second node (e.g., SN 420) may refer to a base station that supports the second cellular communication. According to an embodiment, the processor 520 may include an RFIC (e.g., third RFIC 226 in FIG. 2) and/or an RFFE (e.g., third RFFE 236 in FIG. 2) related to the second cellular communication.

Hereinafter, the description will be provided in assumption of an Evolved Universal Terrestrial Radio Access-New Radio (E-UTRA-NR) dual connectivity (EN-DC) environment of the first cellular communication in the fourth-generation mobile communication method and the second cellular communication in the fifth-generation mobile communication method, the dual connectivity environment of the electronic device 101 is not necessarily limited to the EN-DC environment. For example, the dual connectivity of the electronic device 101 may include an E-UTRA-NR dual connectivity (EN-DC) environment of the first cellular communication in the fourth-generation mobile communication method and the second cellular communication in the fifth-generation mobile communication method, an NR-E-UTRA dual connectivity (NE-DC) environment of the first cellular communication in the fifth-generation mobile communication method and the second cellular communication in the fourth-generation mobile communication method, an NR-NR dual connectivity (NR-DC) environment of the first cellular communication supporting a first method of the fifth-generation mobile communication method (e.g., about 6 GHz or lower) and the second cellular communication supporting a second method of the fifth-generation mobile communication method (e.g., about 6 GHz or higher), or a DC environment of the first cellular communication supporting a first method of the fourth-generation mobile communication method and the second cellular communication supporting a second method of the fourth-generation mobile communication method.

According to an embodiment, the electronic device 101 may use both the first cellular communication and the second cellular communication. The electronic device 101 may transmit and/or receive data for connecting the second cellular communication with the first node (e.g., MN 410) using the first cellular communication. As an example, the data for connecting the second cellular communication may include a radio resource control message (e.g., RRC reconfiguration message). According to an embodiment, the processor 520 may transmit or receive data with an external electronic device (not illustrated) using the communication circuit 550. For example, the processor 520 may transmit and/or receive data using the first cellular communication and/or the second cellular communication by controlling the communication circuit 550.

According to an embodiment, the processor 520 may obtain information related to the operation state of the electronic device 101. The processor 520 may receive information related to the operation state of the electronic device 101. The information related to the operation state of the electronic device 101 may include the temperature of the electronic device 101, whether the display 530 is turned on or off, throughput, and whether a specific application (e.g., a high heat-generating game application) is running. As an example, the temperature of the electronic device 101 may include the individual temperature or combined temperature of at least one module included in the electronic device 101 (e.g., processor 520, communication circuit 550, or communication circuit 550). Alternatively, the temperature of the electronic device 101 may include the temperature measured by the temperature sensor 510 included near the surface of the electronic device 101, but a measurement position of the temperature is not limited. The information related to the operation state of the electronic device 101 may include the throughput of the electronic device 101. The information related to the operation state of the electronic device 101 may include information indicating whether an application running on the electronic device 101 is a designated application (e.g., a high heat-generating application such as a game application).

The electronic device 101 may store a memory (e.g., memory 130 in FIG. 1) that temporarily and/or permanently stores a list of applications for which the release of the RRC connection of the first cellular communication is prohibited. The list of applications may be generated based on the user's selection of the electronic device 101, and may also be received from a server existing external to the electronic device 101 (e.g., electronic device 104 in FIG. 1).

Alternatively, the list of applications may be generated based on the characteristics of the service provided by the application. For example, an application that provides a service for which smooth service performance is difficult (e.g., voice over NR (VoNR)) as the connected cellular communication of the electronic device 101 switches may be included in the list of applications.

The processor 520 may maintain the connection of the first cellular communication without releasing the connection of the first cellular communication when the display 530 is detected to be in an inactive state while an application included in the list of applications for which the release of the RRC connection of the first cellular communication is prohibited is running, regardless of whether the throughput and/or temperature satisfy the designated condition.

According to an embodiment, the electronic device 101 may include a memory (e.g., memory 130 in FIG. 1) that temporarily and/or permanently stores a list of applications for which the release of the connection of the first cellular communication is allowed. The list of applications may be generated based on the user's selection of the electronic device 101, and may also be received from a server existing external to the electronic device 101 (e.g., electronic device 104 in FIG. 1).

Alternatively, the list of applications may be generated based on the characteristics of the service provided by the application. For example, an application that provides a service for which smooth service performance is possible (e.g., a streaming service that is a service using a method of receiving data at every designated time) as the connected cellular communication of the electronic device 101 switches may be included in the list of applications.

The processor 520 may identify whether the throughput and/or temperature satisfy the designated condition in response to identifying that the display 530 has been in an inactive state for a designated period of time or more while an application included in the list of applications for which the release of the first cellular communication is allowed is running. The processor 520 may release the RRC connection of the first cellular communication in response to the throughput and/or temperature satisfying the designated condition. Alternatively, an application processor (not illustrated) may identify that the temperature and/or throughput satisfies the designated condition and transmit a message to a communication processor (not illustrated) indicating the release of the RRC connection of the first cellular communication.

According to an embodiment, the processor 520 may control the connection of the first cellular communication (e.g., LTE) on the basis of the information related to the operation state of the electronic device 101. According to an embodiment, the processor 520 may identify whether the operation state of the electronic device 101 satisfies the designated condition related to releasing the connection of the first cellular communication when using the first cellular communication and the second cellular communication. For example, the processor 520 may determine that a condition related to at least one of releasing the connection of the first cellular communication or releasing the connection of the second cellular communication is satisfied when the temperature of the electronic device 101 is at designated temperature or higher (e.g., about 43° C.). Alternatively, the processor 520 may determine that a designated condition related to releasing the connection of one of the first cellular communication or the second cellular communication is satisfied on the basis of identifying that the throughput of the electronic device 101 is less than or equal to (or less than) a designated value. The processor 520 may determine that a designated condition related to releasing the connection of one of the first cellular communication or the second cellular communication is satisfied in response to identifying that the display 530 has been in an inactive state for a designated period of time or more.

According to an embodiment, the processor 520 may transmit a signal related to releasing the connection of the first cellular communication to the communication circuit 550 on the basis of determining that the operation state of the electronic device 101 satisfies the designated condition related to releasing the connection of the first cellular communication. According to an embodiment, the signal related to releasing the connection of the first cellular communication may include information on the operation state of the electronic device 101 that satisfies the designated condition related to releasing the connection of the first cellular communication. According to an embodiment, the signal related to releasing the connection of the first cellular communication may include a signal indicating the release of the connection of the first cellular communication.

According to an embodiment, the communication circuit 550 may receive a signal related to releasing the connection of the first cellular communication from the processor 520. According to an embodiment, the signal related to releasing the connection of the first cellular communication may include data indicating that the operation state of the electronic device 101 has satisfied the designated condition related to releasing the connection of the first cellular communication, or data indicating the release of the connection of the first cellular communication.

The processor 520 may control to release the connection with the 5G network and connect to the LTE network on the basis of identifying that the number of layers in an NR reception point is greater than the number of layers in an LTE reception point. The number of layers may refer to the number of data streams or paths that a single base station may simultaneously transmit to a terminal. For example, the number of layers may refer to the number of data streams transmitted through each path. For example, two layers may include two paths for transmitting signals. The number of layers may increase in proportion to the number of antennas (e.g., first antenna 540 and second antenna 542). In addition, the processor 520 may determine that a second condition is satisfied on the basis of identifying that the number of layers in the LTE reception point is greater than the number of layers in the NR reception point. The processor 520 may identify whether the transmission power on the communication circuit 550 or the transmission power of the LTE network is relatively higher than the transmission power on the communication circuit 550 or the transmission power of the 5G network on the basis of the second condition being satisfied.

In an embodiment, the processor 520 may determine that setting for measuring communication quality (e.g., B2 event) is satisfied on the basis of reference signal received power (RSRP) of the LTE network positioned in a cell supporting a first network being less than a preset first level, and at the same time, RSRP of a cell supporting a second network exceeding a preset second level.

In an embodiment, the processor 520 may apply an offset to at least one of the RSRP of the LTE network or the RSRP of the NR network in response to not satisfying the setting for measuring communication quality (e.g., B2 event). The processor 520 may apply a negative offset to the RSRP of the LTE network in response to the RSRP of the LTE network exceeding the first level, controlling the RSRP to be less than the first level. The processor 520 may apply a positive offset to the RSRP of the NR network in response to the RSRP of the NR network being less than the second level, controlling the RSRP to exceed the second level. In an embodiment, the processor 520 may control to satisfy the setting for measuring communication quality (e.g., B2 event) by using the offset. The processor 520 may advance a transmission occasion of the measurement report by using the offset. The processor 520 may advance the transmission occasion of the measurement report to receive a response signal to stop the first cellular communication more quickly from at least one of the base station supporting the first cellular communication or the LTE base station 440. The measurement report and the response signal to stop the first cellular communication will be described below.

In an embodiment, the processor 520 may transmit the measurement report to at least one of the base stations supporting the first cellular communication or the LTE base station 440 on the basis of satisfying the setting for measuring communication quality (e.g., B2 event). For example, the LTE base station 440 that has received the measurement report may transmit a response signal to stop the first cellular communication to the electronic device 101 on the basis of the measurement report. The response signal to stop the first cellular communication may include, for example, a handover command. Handover may refer to an operation in which the electronic device synchronizes to a communication channel and connects to a service when moving from one cell to another.

In an embodiment, the processor 520 may connect the communication circuit 550 to the NR network on the basis of the response signal to stop the first cellular communication. The processor 520 may release the connection with the LTE network on the basis of the communication circuit 550 being connected to the NR network. The electronic device 101 may subsequently operate in a stand alone (SA) mode with only the NR network connected.

According to an embodiment, the first cellular communication may include at least one of a long term evolution (LTE) network or a new radio (NR) network, and the second cellular communication may include an NR network or an LTE network.

According to an embodiment, the communication circuit 550 may transmit a signal for releasing the connection of one of the first cellular communication or the second cellular communication to the first node (e.g., MN 410) through the first cellular communication. For example, a signal requesting the release of the connection of the first cellular communication (e.g., measurement report) may include information indicating the result of the quality measurement of the first cellular communication and/or whether an event included in the measurement report is satisfied.

According to an embodiment, the processor 520 may control the communication circuit 550 to connect to the second cellular communication and then release the connection of the first cellular communication when receiving a connection release signal for the first cellular communication as a response signal to the signal for releasing the connection of the first cellular communication from the first node (e.g., MN 410).

For example, a setting for measuring the communication quality with the second node (e.g., SN 420) (e.g., B2 event setting) may include communication quality criteria for initiating a measurement to report the communication quality with the second node (e.g., SN 420) to the first node (e.g., MN 410) for the connection with the second node (e.g., SN 420). As an example, the communication quality result with the second node (e.g., SN 420) may include at least one of reference signal received power (RSRP), reference signal received quality (RSRQ), or received signal strength indicator (RSSI).

According to an embodiment, the processor 520, via the first communication circuit, may release the connection with the first cellular communication (e.g., LTE) on the basis of being connected to the second cellular communication.

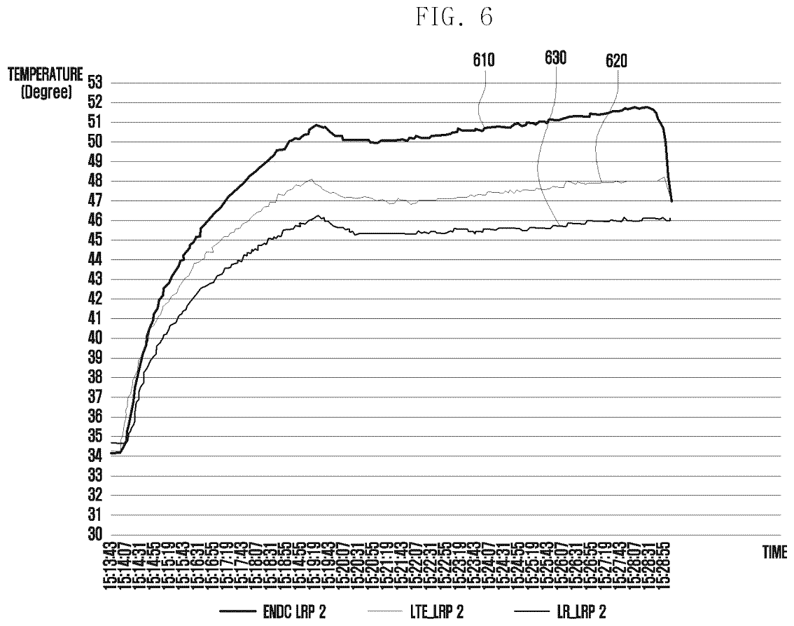

FIG. 6 illustrates temperature measurement results of each network in an EN-DC environment according to an embodiment, in a graph.

In FIG. 6, the horizontal axis of the graph represents the measurement time (seconds), and the vertical axis represents the temperature in degrees Celsius. A first graph 610 represents the temperature distribution on the surface of the electronic device 101 when both the LTE network and the NR network are used simultaneously in an EN-DC situation. A second graph 620 represents the temperature distribution on the surface of the electronic device 101 when only the LTE network is used after blocking the NR network. A third graph 630 represents the temperature distribution on the surface of the electronic device 101 when only the NR network is used after blocking the LTE network. In FIG. 6, the third graph 630 may be positioned below the second graph 620.

In a situation where the power consumed on the LTE network is greater than the power consumed on the NR network, and the number of layers is also relatively greater for the LTE network, the electronic device 101 may block the LTE network instead of the NR network to more efficiently reduce current consumption and/or heat generation. The electronic device 101 may block the LTE network instead of the NR network to achieve a relatively greater reduction in the surface temperature of the electronic device 101.

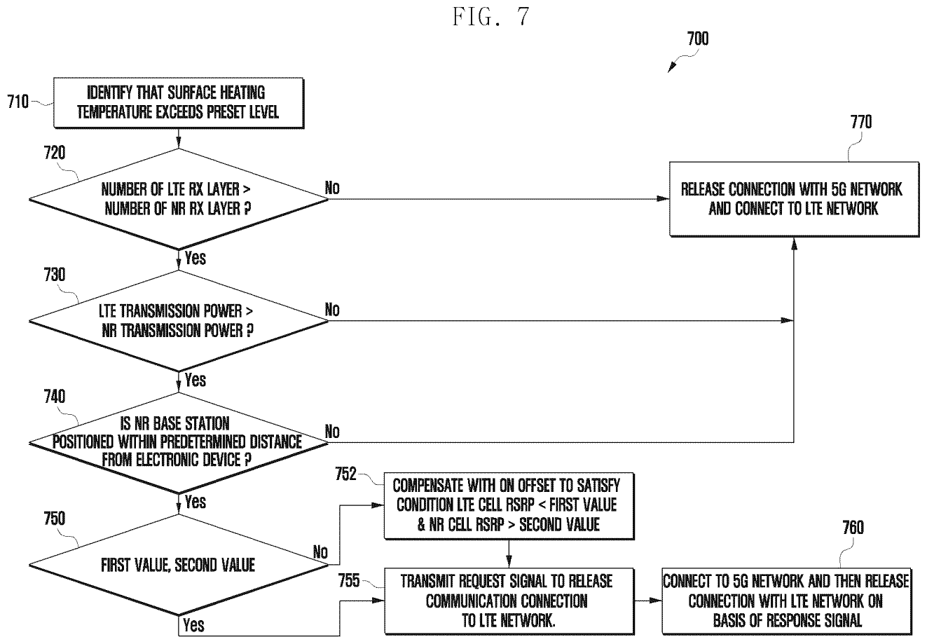

FIG. 7 is a flowchart for controlling heat generation in an electronic device in an EN-DC environment according to an embodiment.

The operations described through FIG. 7 may be implemented based on instructions that can be stored in a computer-readable medium or memory (e.g., memory 130 in FIG. 1).

An illustrated method 700 may be performed by the electronic device described previously through FIG. 1 to FIG. 5C (e.g., electronic device 101 in FIG. 1), and the previously described technical features will be omitted hereinafter. The processor (e.g., processor 520 in FIG. 5) may execute the instructions stored in memory 130 to perform the operations of the illustrated method 700. The order of respective operations in FIG. 7 may be changed, some operations may be omitted, and some operations may be performed simultaneously.

In an embodiment, the E-UTRA-NR dual connectivity (EN-DC) may refer to a technology in which a single terminal is connected to both an LTE network and a 5G network to receive services. In an EN-DC environment, a primary component carrier (PCC) may transmit signals from the LTE network, and a secondary component carrier (SCC) may transmit signals from the 5G network. Hereinafter, new radio (NR) may refer to 5G radio access technology. E-UTRA may refer to LTE radio access technology.

At operation 710, the electronic device 101 may identify that surface heating temperature exceeds a preset level. For example, the electronic device 101 may identify that the surface heating temperature exceeds about 43° C. using the sensor module (e.g., sensor module 176 in FIG. 1). The electronic device 101 may block the connection with one network in an EN-DC situation to reduce current consumption and/or heat generation when the surface heating temperature exceeds a preset level. The electronic device 101 according to an embodiment of the present document may block the connection with the network that has a relatively higher current consumption value based on the current consumption values of the 5G network and the LTE network.

However, the electronic device 101 may perform a procedure to identify whether a specific condition is satisfied for switching to the 5G (NR) network in a stand alone (SA) environment where the LTE network is blocked and only the 5G network is connected. This will be described in operations 720 to 750.

At operation 720, the electronic device 101 may compare the number of layers in the LTE reception point with the number of layers in the NR reception point to identify whether the number of layers in the LTE reception point is greater. The number of layers may be proportional to the number of component carriers (CC) and the number of antennas. For example, in a 3CA, 4×4 layer environment, the number of layers may be 12 (3*4). In a 2CA, 2×2 layer environment, the number of layers may be 4 (2*2). At operation 770, the electronic device 101 may control to release the connection with the 5G network and connect to the LTE network on the basis of identifying that the number of layers in the NR reception point is greater than the number of layers in the LTE reception point. At operation 730, the electronic device 101 may identify whether the transmission power of the LTE network is relatively higher than the transmission power of the 5G network on the basis of identifying that the number of layers in the LTE reception point is greater than the number of layers in the NR reception point.

At operation 770, the electronic device 101 may control to release the connection with the 5G network and connect to the LTE network on the basis of identifying that the transmission power of the LTE network is relatively lower than the transmission power of the 5G network. At operation 740, the electronic device 101 may identify whether the NR base station is positioned within a predetermined distance from the electronic device 101 on the basis of identifying that the transmission power of the LTE network is relatively higher than the transmission power of the 5G network.

At operation 770, the electronic device 101 may control to release the connection with the 5G network and connect to the LTE network on the basis of identifying that the NR base station is not positioned within a predetermined distance from the electronic device 101. At operation 750, the electronic device 101 may identify a condition (B2) for transmitting the measurement report on the basis of identifying that the NR base station is positioned within a predetermined distance from the electronic device 101. The network may transmit a handover command to the electronic device 101 on the basis of the measurement report. The electronic device 101 may release the connected LTE network and switch to a stand alone (SA) mode on the basis of the handover command. Handover may refer to an operation in which the electronic device synchronizes to a communication channel and connects to a service when moving from one cell to another.

According to an embodiment, the condition (B2) for transmitting the measurement report is as follows. The reference signal received power (RSRP) value of the LTE cell may be less than a preset first value, and the reference signal received power (RSRP) value of the NR cell may be greater than a preset second value. The electronic device 101 may transmit the measurement report to the base station on the basis of satisfying the condition (B2). The RSRP may refer to the strength of a signal received by the electronic device 101.

The electronic device 101 may perform operation 750 on the basis of the reference signal received power (RSRP) value of the LTE cell being less than a preset first value and the reference signal received power (RSRP) value of the NR cell being greater than a preset second value. Operation 750 may refer to an operation in which the electronic device 101 transmits a request signal to release the communication connection to the LTE network.

According to an embodiment, the electronic device 101 may control to satisfy the condition (B2) for transmitting the measurement report by applying an offset at operation 752, even if the condition (B2) for transmitting the measurement report is not satisfied. The electronic device 101 may transmit a request signal to release the communication connection to the LTE network at operation 755 on the basis of the condition (B2) for transmitting the measurement report being satisfied by applying the offset. The electronic device 101 may identify that the current consumption of the LTE network is higher than the current consumption of the NR network on the basis of operation 720 and operation 730, and may apply an offset to quickly switch to a stand alone (SA) mode using only the NR network. The electronic device 101 may satisfy the condition (B2) for transmitting the measurement report by using the offset and may release the communication connection with the LTE network. After operation 755, at operation 760, the electronic device 101 may connect to the 5G network and then release the connection with the LTE network on the basis of a response signal from the network. The response signal may include, for example, a redirection or handover command. The electronic device 101 may turn off the LTE network, which has relatively higher current consumption, and connect to the 5G network without interruption on the basis of operations 710 to 760. Redirection, like handover, refers to an operation in which the electronic device synchronizes to a communication channel and connects to a service when moving from one cell to another cell, but differs from handover in that the electronic device disconnects from the existing cell before moving to another cell.

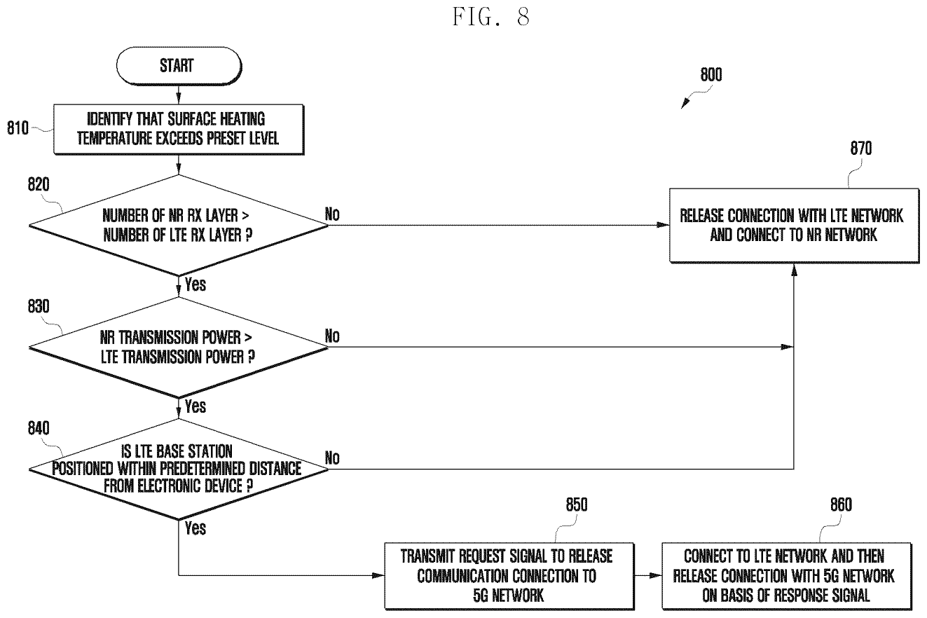

FIG. 8 is a flowchart for controlling heat generation in an electronic device in an NE-DC environment according to an embodiment.

The operations described through FIG. 8 may be implemented based on instructions that can be stored in a computer-readable medium or memory (e.g., memory 130 in FIG. 1).

An illustrated method 800 may be performed by the electronic device described previously through FIG. 1 to FIG. 5C (e.g., electronic device 101 in FIG. 1), and the previously described technical features will be omitted hereinafter. The processor (e.g., processor 520 in FIG. 5) may execute the instructions stored in memory (e.g., memory 130 in FIG. 1) to perform the operations of the illustrated method 800. The order of respective operations in FIG. 8 may be changed, some operations may be omitted, and some operations may be performed simultaneously.

In an embodiment, NR E-UTRA dual connectivity (NE-DC) may refer to a technology in which a single terminal is connected to both an LTE network and a 5G network to receive services. In an NE-DC environment, the primary component carrier (PCC) may transmit signals from the 5G network, and the secondary component carrier (SCC) may transmit signals from the LTE network. In NE-DC, compared to EN-DC in the previous FIG. 7, the signals transmitted by the PCC and SCC may be opposite.

At operation 810, the electronic device 101 may identify that surface heating temperature exceeds a preset level. For example, the electronic device 101 may identify that the surface heating temperature exceeds about 43° C. using the sensor module (e.g., sensor module 176 in FIG. 1). The electronic device 101 may block the connection with one network in an NE-DC situation when the surface heating temperature exceeds a preset level. The electronic device 101 according to an embodiment of the present document may block the connection with the network that has a relatively higher current consumption value based on the current consumption values of the 5G network and the LTE network.

However, the electronic device 101 may perform a procedure to identify whether a specific condition is satisfied for switching to the 5G (NR) network in a stand alone (SA) environment where the LTE network is blocked and only the 5G network is connected. This will be described in operations 820 to 840.

At operation 820, the electronic device 101 may compare the number of layers in the LTE reception point with the number of layers in the NR reception point to identify whether the number of layers in the NR reception point is greater. The number of layers may be proportional to the number of component carriers (CC) and the number of antennas. For example, in a 3CA, 4×4 layer environment, the number of layers may be 12 (3*4). In a 2CA, 2×2 layer environment, the number of layers may be 4 (2*2). At operation 870, the electronic device 101 may control to release the connection with the LTE network and connect to the NR network on the basis of identifying that the number of layers in the NR reception point is less than the number of layers in the LTE reception point. At operation 830, the electronic device 101 may identify whether the transmission power of the 5G (NR) network is relatively higher than the transmission power of the LTE network on the basis of identifying that the number of layers in the NR reception point is greater than the number of layers in the LTE reception point.

At operation 870, the electronic device 101 may control to release the connection with the LTE network and connect to the 5G network on the basis of identifying that the transmission power of the 5G network is relatively lower than the transmission power of the LTE network. At operation 840, the electronic device 101 may identify whether the LTE base station is positioned within a predetermined distance from the electronic device 101 on the basis of identifying that the transmission power of the 5G network is relatively higher than the transmission power of the LTE network.

At operation 870, the electronic device 101 may control to release the connection with the LTE network and connect to the 5G network on the basis of identifying that the LTE base station is not positioned within a predetermined distance from the electronic device 101. At operation 850, the electronic device 101 may transmit a request signal to release the communication connection to the 5G network on the basis of identifying that the LTE base station is positioned within a predetermined distance from the electronic device 101. The network may transmit a redirection or handover command to the electronic device 101 on the basis of the measurement configuration. At operation 860, the electronic device 101 may release the connected 5G network on the basis of the measurement configuration and operate on the LTE network.

An electronic device may include a first communication circuit configured to perform first cellular communication with a first cellular network, a second communication circuit configured to perform second cellular communication with a second cellular network, and at least one processor operatively connected to the first communication circuit and the second communication circuit. The processor may connect to the first cellular network and the second cellular network through the first communication circuit and the second communication circuit, determine a network to be released from connection, between the first cellular network and the second cellular network, on the basis of whether at least one condition is satisfied among a first condition related to surface heating temperature of the electronic device, a second condition related to the number of layers received through the first cellular communication and the number of layers received through the second cellular communication, and a third condition related to magnitude of transmission power of the first communication circuit and the second communication circuit, transmit a signal for releasing communication connection to a determined network between the first cellular network and the second cellular network, and perform a series of operations for releasing communication connection from the determined network on the basis of a response signal to the release signal.

In an embodiment, the first condition may refer to the surface heating temperature of the electronic device exceeding a preset level.

In an embodiment, the first cellular network may include a long term evolution (LTE) network, and the second cellular network may include a new radio (NR) network (e.g., a 5G network).

In an embodiment, the processor may identify whether a base station of the new radio (NR) network is positioned within a predetermined distance from the electronic device on the basis of determining to release the connection with the first cellular network, and, in response of a base station of the NR network not being positioned within a predetermined distance from the electronic device, determine to release the connection with the second cellular network instead of releasing the connection with the first cellular network.

In an embodiment, the processor may determine to release the connection with the first cellular network on the basis of a reference signal received power (RSRP) value of a cell supporting the first network being less than a preset first value and a reference signal received power (RSRP) value of a cell supporting the second network exceeding a preset second value.

In an embodiment, the processor may determine to release the connection with the second cellular network instead of releasing the connection with the first cellular network on the basis of a reference signal received power (RSRP) value of a cell supporting the first network exceeding a preset first value or a reference signal received power (RSRP) value of a cell supporting the second network being less than a preset second value.

In an embodiment, the processor may determine that current consumption of the first communication circuit is relatively greater than current consumption of the second communication circuit on the basis of the number of layers received through the first cellular communication exceeding the number of layers received through the second cellular communication, and may determine that the current consumption of the first communication circuit is relatively greater than the current consumption of the second communication circuit on the basis of signal strength of the first communication circuit being relatively greater than signal strength of the second communication circuit.

In an embodiment, the processor may transmit a measurement report to the first cellular network on the basis of determining that current consumption of the first communication circuit is relatively greater than current consumption of the second communication circuit.

In an embodiment, the processor may release the connection between the first communication circuit and the first cellular network on the basis of receiving a handover command from the first cellular network, and connect the first communication circuit to the second cellular network.

In an embodiment, the processor may identify temperature of at least one module included in the electronic device through a sensor module.

In an embodiment, the first communication circuit may switch to a sleep state or a power-off state on the basis of release of the connection of the first cellular communication, and the second communication circuit may switch to a sleep state or a power-off state on the basis of release of the connection of the second cellular communication.

A method of controlling an electronic device may include determining a network to be released from connection, between the first cellular network and the second cellular network, on the basis of whether at least one condition is satisfied among a first condition related to surface heating temperature of the electronic device, a second condition related to the number of layers received through the first cellular communication and the number of layers received through the second cellular communication, and a third condition related to magnitude of transmission power of the first communication circuit and the second communication circuit, transmitting a signal for releasing communication connection to a determined network between the first cellular network and the second cellular network, and performing a series of operations for releasing communication connection from the determined network on the basis of a response signal to the release signal. The first cellular network may include a long term evolution (LTE) network, and the second cellular network may include a new radio (NR) network. According to a non-limiting embodiment, the electronic device may operate in a DC state, and the processor may release the connection between the first communication circuit and the first cellular network while maintaining connection between the second communication circuit and the second cellular network. According to a non-limiting embodiment, the electronic device may operate in a DC state, and the processor may release the connection between the second communication circuit and the second cellular network while maintaining connection between the first communication circuit and the first cellular network.

1. An electronic device, comprising:
a first communication circuit configured to perform first cellular communication with a first cellular network;
a second communication circuit configured to perform second cellular communication with a second cellular network; and
at least one processor operatively connected to the first communication circuit and the second communication circuit,
wherein the processor is configured to:
connect to the first cellular network and the second cellular network through the first communication circuit and the second communication circuit;
determine a network to be released from connection, between the first cellular network and the second cellular network, based on whether at least one condition is satisfied among a first condition related to surface heating temperature of the electronic device, a second condition related to a number of layers received through the first cellular communication and a number of layers received through the second cellular communication, and a third condition related to magnitude of transmission power of the first communication circuit and the second communication circuit;
transmit a release signal for releasing communication connection to a determined network between the first cellular network and the second cellular network; and
perform a series of operations for releasing communication connection from the determined network based on a response signal to the release signal.

2. The electronic device of claim 1, wherein the first cellular network includes a long term evolution (LTE) network, and the second cellular network may include a new radio (NR) network.

3. The electronic device of claim 2, wherein the processor identifies whether a base station of the new radio (NR) network is positioned within a predetermined distance from the electronic device based on determining to release connection with the first cellular network, and, in response of a base station of the new radio (NR) network not being positioned within a predetermined distance from the electronic device, determines to release connection with the second cellular network instead of releasing the connection with the first cellular network.

4. The electronic device of claim 3, wherein the processor determines to release the connection with the first cellular network based on a reference signal received power (RSRP) value of a cell supporting the first network being less than a preset first value and a reference signal received power (RSRP) value of a cell supporting the second network exceeding a preset second value.

5. The electronic device of claim 4, wherein the processor determines to release the connection with the second cellular network instead of releasing the connection with the first cellular network based on the reference signal received power (RSRP) value of the cell supporting the first network exceeding the preset first value or the reference signal received power (RSRP) value of the cell supporting the second network being less than the preset second value.

6. The electronic device of claim 1, wherein the processor determines that current consumption of the first communication circuit is relatively greater than current consumption of the second communication circuit based on the number of layers received through the first cellular communication exceeding the number of layers received through the second cellular communication, and determines that the current consumption of the first communication circuit is relatively greater than the current consumption of the second communication circuit based on signal strength of the first communication circuit being relatively greater than signal strength of the second communication circuit.

7. The electronic device of claim 6, wherein the processor transmits a measurement report to the first cellular network based on determining that the current consumption of the first communication circuit is relatively greater than the current consumption of the second communication circuit.

8. The electronic device of claim 7, wherein the processor releases connection between the first communication circuit and the first cellular network based on receiving a handover command from the first cellular network, and connects the first communication circuit to the second cellular network.

9. The electronic device of claim 1, further comprising:
a sensor module,
wherein the processor identifies temperature of at least one module included in the electronic device through the sensor module.

10. The electronic device of claim 1, wherein the first communication circuit switches to a sleep state or a power-off state based on release of connection of the first cellular communication, and the second communication circuit switches to a sleep state or a power-off state based on release of connection of the second cellular communication.

11. The electronic device of claim 1, wherein the first condition refers to surface heating temperature of the electronic device exceeding a preset level.

12. A method of controlling an electronic device, the method comprising:
determining a network to be released from connection, between the first cellular network and the second cellular network, based on whether at least one condition is satisfied among a first condition related to surface heating temperature of the electronic device, a second condition related to a number of layers received through the first cellular communication and a number of layers received through the second cellular communication, and a third condition related to magnitude of transmission power of the first communication circuit and the second communication circuit;
transmitting a release signal for releasing communication connection to a determined network between the first cellular network and the second cellular network; and
performing a series of operations for releasing communication connection from the determined network based on a response signal to the release signal,
wherein the first cellular network includes a long term evolution (LTE) network, and the second cellular network includes a new radio (NR) network.

13. The method of claim 12, further comprising:
identifying whether a base station of the new radio (NR) network is positioned within a predetermined distance from the electronic device based on determining to release connection with the first cellular network, and, in response of a base station of the new radio (NR) network not being positioned within a predetermined distance from the electronic device;
determining to release connection with the second cellular network instead of releasing the connection with the first cellular network.

14. The method of claim 12, further comprising:
determining to release the connection with the first cellular network based on a reference signal received power (RSRP) value of a cell supporting the first network being less than a preset first value and a reference signal received power (RSRP) value of a cell supporting the second network exceeding a preset second value.

15. The method of claim 14, further comprising:
determining to release the connection with the second cellular network instead of releasing the connection with the first cellular network on the basis of the reference signal received power (RSRP) value of the cell supporting the first network exceeding the preset first value or the reference signal received power (RSRP) value of the cell supporting the second network being less than the preset second value.

16. An electronic device, comprising:
a first communication circuit configured to perform first cellular communication with a first cellular network;
a second communication circuit configured to perform second cellular communication with a second cellular network; and
a processor configured to operate in a dual connection (DC) state to selectively establish selective with a first cellular network via a first communication circuit and to selectively establish connection with a second cellular network via a second communication circuit,
wherein the processor is configured to determine a first current consumed in the first cellular network with a second current consumed in the second cellular network, and to release the connection with one of the first cellular network or the second cellular network based on a comparison between the first current and the second current to reduce current consumption and heat generation of the electronic device.

17. The electronic device of claim 16, wherein the processor is configured to:
release the connection with the first cellular network and establish connection with the second cellular network in response to consumption of the first current being greater than consumption of the second current; and
release the connection with the second cellular network and establish the connection with the first cellular network in response to consumption of the second current being greater than consumption of the first current.

18. The electronic device of claim 17, wherein the first current consumed in the first cellular network is determined based on a first number of layers received through a first cellular communication with the first cellular network, and the second current consumed in the second cellular network is determined based on a second number of layers received through a second cellular communication with the second cellular network.

19. The electronic device of claim 17, wherein the first current consumed in the first cellular network is determined based on a first signal strength of the first communication circuit, and the second current consumed in the second cellular network is determined based on a second signal strength of the second communication circuit.

20. The electronic device of claim 16, wherein the first cellular network is a long term evolution (LTE) network with the second cellular network is a new radio (NR) network.
